(19) United States
(12) Patent Application Publication
(10) Pub. No.: US 2025/0058249 A1
(43) Pub. Date: Feb. 20, 2025

(54) VARIABLE PERFORATION LIQUID-LIQUID EXTRACTION COLUMN

(71) Applicant: IFP ENERGIES NOUVELLES, RUEIL-MALMAISON CEDEX (FR)

(72) Inventors: Hélène LORCET, RUEIL-MALMAISON CEDEX (FR); Frederic AUGIER, RUEIL-MALMAISON CEDEX (FR); Jeremy GAZARIAN, RUEIL-MALMAISON CEDEX (FR); Pierre-Olivier DREGER, RUEIL-MALMAISON CEDEX (FR)

(73) Assignee: IFP ENERGIES NOUVELLES, RUEIL-MALMAISON CEDEX (FR)

(21) Appl. No.: 18/721,473

(22) PCT Filed: Dec. 12, 2022
(86) PCT No.: PCT/EP2022/085391

§ 371 Date: Jun. 18, 2024

(30) Foreign Application Priority Data
Dec. 20, 2021 (FR) FR2114008

(51) Int. Cl. B01D 11/04

(52) U.S. Cl. CPC B01D 11/043

(57) ABSTRACT

Liquid-liquid extraction column (1) comprising points for feedstock injection (2), washing (3) and backwashing (4), two withdrawal points (5, 6), trays (Pᵢ) located along the column and defining 2 to 30 zones each comprising at least two trays, the n zones comprising: at least one extraction zone Zᵢ comprising the zones from Z₁ to Zₓ, x being greater than or equal to 1, and at least one backwash zone comprising the zones from Zₓ₊₁ to Zₙ, n being greater than x; in which the trays of the same zone have the same number of holes per perforated tray; in which, when x>1, the number of holes per perforated tray of the zones Zᵢ increases when i increases; and when x=1, said number of holes of the backwash zone is less than/greater than than that of the zone Z₁.

### TECHNICAL FIELD

The field of the invention relates to a column (extractor) for the liquid-liquid separation of hydrocarbon compounds, such as aromatic compounds (e.g. A6-A11) from extended hydrocarbon cuts (e.g. C6-C11 cut, such as that from an FCC Fluid Catalytic Cracking unit).

### PRIOR ART

A liquid-liquid extraction operation is a key building block of processes performing the separation of hydrocarbon cuts, such as the separation of a mixture of aromatic and non-aromatic compounds. The operating principle is based on the differences in solubility of compounds of a homogeneous liquid feedstock in a suitable solvent (e.g. an aprotic and polar solvent, such as sulfolane or DMSO). The addition of a partially miscible solvent to the feedstock causes the appearance of a second phase to which a portion of the compounds (e.g. aromatic compounds), which are the most soluble constituents, is preferentially transferred.

Typically, liquid-liquid extraction technology uses a liquid-liquid separation column comprising a plurality of perforated trays equipped with one or more weirs per tray, depending on the targeted capacity (mention is made of a one-pass or two-pass tray or a multi-pass tray when there are more than three weirs).

The design rules for a conventional liquid-liquid extraction column consider a reference tray sized according to the maximum flow rates of each phase and the physicochemical properties thereof. This design is then used for the whole column by stacking a plurality of trays, the trays thus all being substantially identical.

The Applicant has identified, however, that the operation of a liquid-liquid extraction column can give rise to substantial variability, notably depending on:
the flow rate of each of the phases along the column—this phenomenon is linked firstly to the material transfer of solutes from the feedstock to the solvent and secondly to the possibility of modulating the backwash flow rate according to the nature of the feedstock and the targeted specifications; and
the physicochemical properties and in particular the interface tension between the feedstock and the solvent linked to the gradual enrichment in compounds extracted from the feedstock towards the solvent.

The present invention is directed towards overcoming the abovementioned drawbacks.

### SUMMARY OF THE INVENTION

In the context described previously, a first object of the present description is to propose a liquid-liquid extraction column allowing:
the maintenance of a range of between 5% and 20% of the average volume fraction of dispersed phase (i.e. solvent/heavy phase) in a compartment (i.e. a zone comprising a perforated tray and an adjacent inter-tray space);
the non-entrainment of the dispersed-phase droplets into the weirs by the continuous phase (i.e. feedstock/light phase) so as to limit the axial mixing of the dispersed phase;
a coalesced layer height of the dispersed phase on each tray that is sufficient to prevent the passage of the continuous phase through the perforated tray (and to force the passage only of the continuous phase into the weirs);
a suitable continuous phase transverse velocity, which does not perturb the flow of the dispersed phase.

Surprisingly, the Applicant has identified that particular characteristics of perforated trays, such as the number of holes per tray, allow the hydrodynamics to be controlled along the entire column, ensuring a homogeneous coalesced-layer thickness and thus limiting axial mixing.

This technical solution makes it possible to maintain satisfactory material transfer efficiency on each tray.

According to a first aspect, the abovementioned objects, and also other advantages, are obtained by a liquid-liquid extraction column, comprising the following elements:
a first injection point for a first phase located at an intermediate position between the top and the bottom of the column;
a second injection point for a second phase and a third injection point for a backwash liquid, one (of the second and third injection points) being located at the top of the column and the other being located at the bottom of the column; and
a first withdrawal point for an extract and a second withdrawal point for a raffinate, one (of the first and second withdrawal points) being located at the bottom of the column and the other being located at the top of the column;
a plurality of trays located from the top of the column to the bottom of the column and defining n zones, each zone comprising at least two trays, n being between 2 and 30, preferably between 3 and 30;
in which the n zones comprise:
   at least one extraction zone Zᵢ located between a zone (e.g. a column head zone) Z₁ comprising the second injection point for the second phase, and a feed zone Zₓ comprising the first injection point for the first phase, x being greater than or equal to 1 (preferably x is greater than 1); and
   at least one backwash zone located between a zone Zₓ₊₁ and a zone (e.g. column bottom zone) Zₙ comprising the third injection point for the backwash liquid, n being greater than x;
in which the trays of the same zone have substantially the same number of holes (9); and
in which:
   when x is greater than 1, the number of holes per perforated tray of the zones Zᵢ increases as the value i increases; and
   when x is equal to 1, the number of holes per perforated tray of the at least one backwash zone is less than or greater than the number of holes per perforated tray of the zone Z₁.

According to one or more embodiments, n is between 3 and 30, and x is greater than 1.

According to one or more embodiments, the liquid-liquid extraction column comprises the following elements:
a first injection point for a first phase located at an intermediate position between the top and the bottom of the column;
a second injection point for a second phase located at the top of the column; and
a third injection point for a backwash liquid located at the bottom of the column;
a first withdrawal point for an extract located at the bottom of the column;
a second withdrawal point for a raffinate located at the top of the column;
a plurality of trays located from the top of the column to the bottom of the column and defining n zones, each zone comprising at least two trays, n being between 3 and 30;
in which the n zones comprise:
a plurality of extraction zones Zᵢ located between a column head zone Z₁ comprising the second injection point for the second phase, and a feed zone Zₓ comprising the first injection point for the first phase, x being greater than 1; and
at least one backwash zone located between a zone Zₓ₊₁ and a column bottom zone Zₙ comprising the third injection point for the backwash liquid, n being greater than x;
in which the trays in the same zone have substantially the same number of holes; and
in which the number of holes per perforated tray of the zones Zᵢ increases as the value i increases.

According to one or more embodiments, in the extraction zones Zᵢ where i ranges from 1 to x (i.e. x greater than 1), the ratio of the number of holes per perforated tray in a zone Zᵢ to the number of holes per perforated tray in a zone Zᵢ₊₁ is between 0.40 and 0.95.

According to one or more embodiments, in the extraction zones Zᵢ where i ranges from 1 to x (i.e. x greater than 1), the ratio of the number of holes per perforated tray in a zone Zᵢ to the number of holes per perforated tray in a zone Zᵢ₊₁ is between 0.60 and 0.95.

According to one or more embodiments, in the extraction zones Zᵢ where i ranges from 1 to x (i.e. x greater than 1), the ratio of the number of holes per perforated tray in a zone Zᵢ to the number of holes per perforated tray in a zone Zᵢ₊₁ is between 0.80 and 0.95.

According to one or more embodiments, when x is 1, the ratio of the number of holes per perforated tray of the at least one backwash zone to the number of holes per perforated tray of the zone Z₁ is between 0.40 and 0.95, or the ratio of the number of holes per perforated tray in the zone Z₁ to the number of holes per perforated tray of the at least one backwash zone is between 0.40 and 0.95.

According to one or more embodiments, the at least one backwash zone is a plurality of zones, from zone Zₓ₊₁ to zone (e.g. column bottom zone) Zₙ, and in which the number of holes per perforated tray is constant from zone Zₓ₊₁ to zone Zₙ.

According to one or more embodiments, the at least one backwash zone is a plurality of zones, from zone Zₓ₊₁ to zone (e.g. column bottom zone) Zₙ, and in which the number of holes per perforated tray increases from zone Zₓ₊₁ to zone Zₙ.

According to one or more embodiments, the at least one backwash zone is a plurality of zones Zⱼ located between the zone Zₓ₊₁ and the zone (e.g. column bottom zone) Zₙ, and in the zones Zⱼ where j ranges from x+1 to n, the ratio of the number of holes per perforated tray in a zone Zⱼ to the number of holes per perforated tray in a zone Zⱼ₊₁ is between 0.70 and 0.95.

According to one or more embodiments, in the zones Zⱼ where j ranges from x+1 to n, the ratio of the number of holes per perforated tray in a zone Zⱼ to the number of holes per perforated tray in a zone Z₁ is between 0.70 et 0.90.

According to one or more embodiments, in the zones Zⱼ where j ranges from x+1 to n, the ratio of the number of holes per perforated tray in a zone Zⱼ to the number of holes per perforated tray in a zone Z₁ is between 0.80 et 0.90.

According to one or more embodiments, the number of zones Zᵢ is between 2 and 10 and/or the number of backwash zones is between 1 and 10.

According to one or more embodiments, the number of holes in the perforated trays of the backwash zone Zₓ₊₁ is less than, equal to or greater than the number of holes in the perforated trays of the extraction zone Zₓ.

According to one or more embodiments, the number of holes in the perforated trays of the backwash zone Zₓ₊₁ is greater than the number of holes in the perforated trays of the extraction zone Zₓ.

According to one or more embodiments, each perforated tray has a number of holes of between 3000 and 20 000.

According to one or more embodiments, the ratio of the area of the holes of each tray to the total area of each tray is less than 0.5.

According to one or more embodiments, the diameter of the holes of the trays is between 2 mm and 20 mm.

Embodiments of the liquid-liquid extraction column according to the first aspect and also other characteristics and advantages will become apparent on reading the following description, which is given purely as a non-limiting illustration, and with reference to the following drawings.

### LIST OF FIGURES

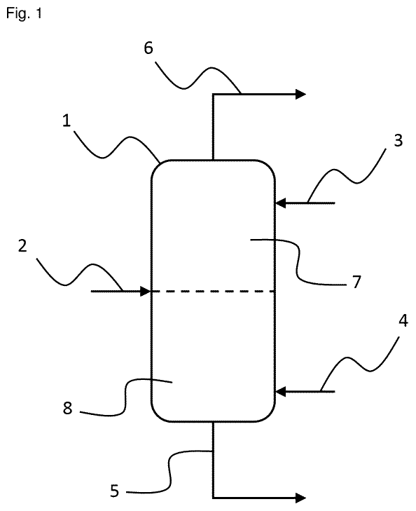

The FIG. 1 schematically shows a cross-sectional view of a liquid-liquid extraction column according to the present invention.

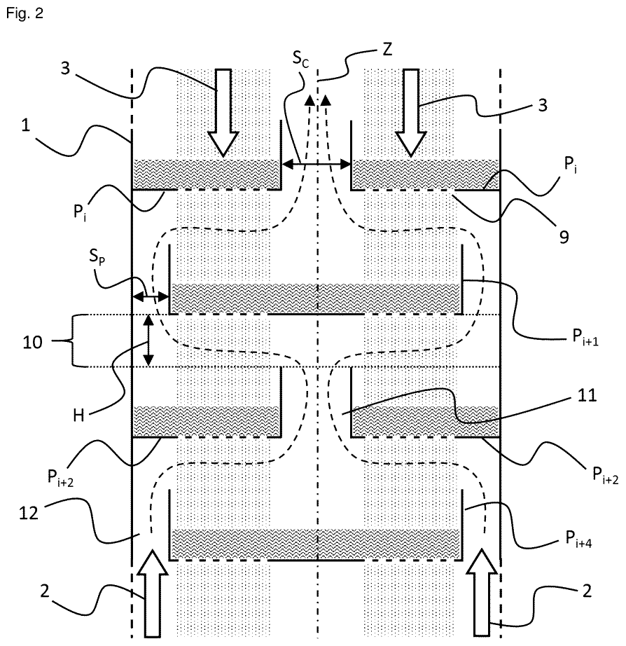

The FIG. 2 schematically shows a cross-sectional view of the flow of the dispersed phase and of the continuous phase in a liquid-liquid extraction column according to the present invention.

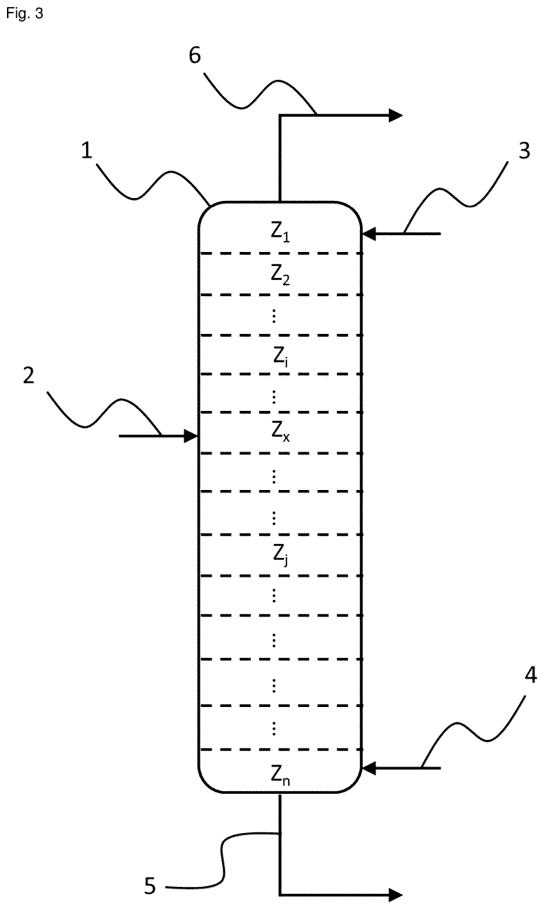

The FIG. 3 schematically shows a cross-sectional view of a liquid-liquid extraction column according to the present invention defined by a plurality of zones Zᵢ located between the column head zone 1 and the feed zone Zₓ, and a plurality of zones Zⱼ located between the zone Zₓ₊₁ and the column bottom zone Zₙ.

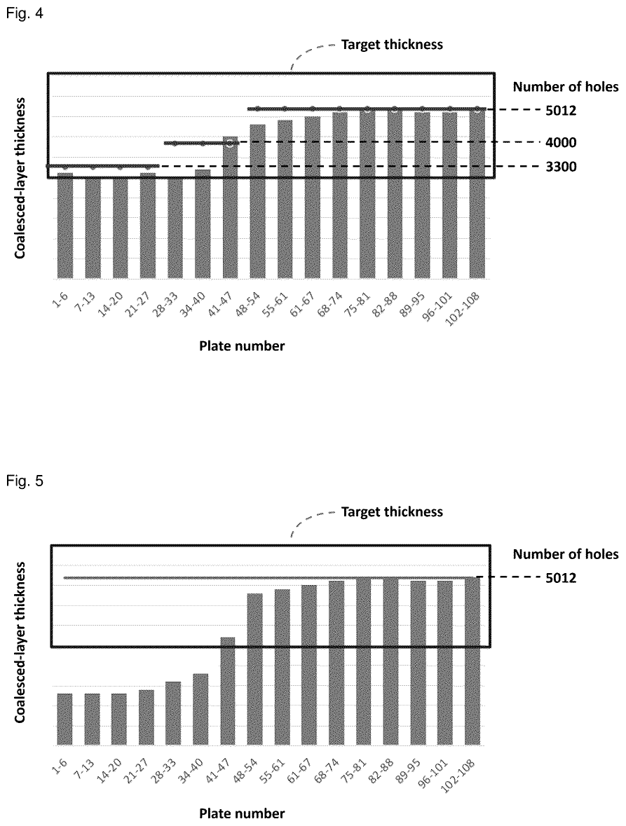

The FIG. 4 is a graph showing the change in the thickness of the coalesced layer along a liquid-liquid extraction column according to the present invention, in which the number of holes in the trays Pₗ is variable.

The FIG. 5 is a graph showing the change in the thickness of the coalesced layer along a reference liquid-liquid extraction column, in which the number of holes in the trays Pₗ is constant.

### DESCRIPTION OF THE EMBODIMENTS

Embodiments of the invention will now be described in detail. In the following detailed description, many specific details are presented in order to provide a deeper understanding of the invention. However, it will be apparent to a person skilled in the art that the invention can be performed without these specific details. In other cases, well-known characteristics have not been described in detail in order to avoid unnecessarily complicating the description.

In the present description, the term “comprise” is synonymous with (means the same as) “include” and “contain”, and is inclusive or open-ended and does not exclude other unrecited elements. It is understood that the term “comprise” includes the exclusive and closed term “consist”. In addition, in the present description, the term “substantially” corresponds to an approximation of ±10%, preferably of ±5%, very preferably of ±2%, of a reference value such as a distance, velocity, flow rate, compound content, temperature, pressure, etc.

With reference to FIG. 1, a liquid-liquid extraction column 1 comprises the following elements:
a first injection point for a first phase 2 (or liquid to be separated), such as a feedstock (e.g. a mixture of aromatic and non-aromatic C6-C11 compounds), located at an intermediate position between the top and bottom of column 1;
a second injection point for a second phase 3 (or separation liquid), such as a solvent (e.g. sulfolane), located at the top of column 1;
a third injection point for a backwash liquid 4, such as a recycle (e.g. a mixture comprising at least 50% by weight of light compounds, (i.e., C5-C8, preferably C5-C6, compounds), located at the bottom of column 1; and
a first withdrawal point for an extract 5 (in liquid phase), such as a solvent enriched in extracted compounds (e.g. aromatic compounds), located at the bottom of column 1; and
a second withdrawal point for a raffinate 6 (in liquid phase), such as a feedstock depleted in extracted compounds, located at the top of column 1.

In addition, in order to increase the yield and purity, two distinct operating zones are defined opposite the injection point of the liquid 2 to be separated:
an extraction sector 7, extending substantially from the first injection point for the first phase 2 to substantially the second injection point for the second phase 3, notably allows the extraction of compounds (e.g. aromatics) from the liquid 2 to be separated by contact with the separation liquid 3 counter-currentwise (the “yield zone”), and
a backwash sector 8, adjacent to the extraction sector 7 and extending substantially to the third injection point for the backwash liquid 4, notably makes it possible to backwash undesired compounds (e.g. heavy non-aromatic compounds) contained in the extract 5 by the backwash liquid 4 in order to ensure a high level of purity.

Specifically with reference to FIG. 1, the separation liquid exits column 1 entraining compounds of interest to be separated (e.g. aromatic compounds) to form the extract 5. The extract may also contain undesired compounds (e.g. light non-aromatic compounds, such as C6-C7 compounds) which can be separated downstream (e.g. by distillation and/or stripping). Advantageously, the extract 5 contains no (or very few) undesired compounds that are difficult to separate (e.g. heavier non-aromatic compounds, such as C8+ compounds), which are separated from the extract in the backwash sector 8. With reference to FIG. 1, the separation liquid 3 is heavier than the liquid 2 to be separated and is injected at the top of column 1 while the backwash liquid 4 is injected at the bottom of column 1. It is understood that the present invention also relates to liquid-liquid extraction columns, in which the separation liquid is lighter than the liquid 2 to be separated, the point of injection of the separation liquid 3 is at the bottom of column 1 and the point of injection of the backwash liquid 4 is at the top of column 1.

With reference to FIG. 2, a two-pass liquid-liquid extraction column 1 comprises n perforated trays Pᵢ, i being between 1 and n. Each perforated tray Pᵢ is arranged so that the dispersed phase (i.e. the separation liquid 3 heavier than the liquid 2 to be separated) flows through the holes 9 in the perforated tray Pᵢ, the droplets of the dispersed phase recoalescing on the next perforated tray Pᵢ₊₁ to form a liquid volume preventing the passage of the continuous phase (i.e. the liquid 2 to be separated lighter than the separation liquid 3) through the perforated tray Pᵢ₊₁. The liquid 2 to be separated flows counter-currentwise relative to the separation liquid 3, i.e. upwards through central weirs 11 and peripheral weirs 12 of cross-section S_{C} and S_{P}, respectively, and transversely through an inter-tray space 10 of height H. With reference to FIG. 2, the heavy phase is the dispersed phase and the light phase is the continuous phase. It is understood that a liquid-liquid extraction column 1 may comprise perforated trays which are adapted so that the dispersed phase is the light phase and the continuous phase is the heavy phase.

According to one or more embodiments, the perforated trays Pᵢ are one-pass (e.g. one type of weir) or two-pass (e.g. two types of weirs) or multi-pass trays.

The Applicant has identified that the operation of a liquid-liquid extraction column can give rise to significant variations in flow rate and in the physicochemical properties of the phases circulating in the column, and that the use of trays which differ according to their position in the column can lead to ensuring homogeneous efficiency of the column, contrary to the prior art.

According to the invention, with reference to FIG. 3, a liquid-liquid extraction column 1 is also defined by:
at least one extraction zone Zᵢ, and preferably a plurality of extraction zones Zᵢ defining the extraction sector 7, i.e. the extraction zone(s) Zᵢ are located between the column head zone Z₁ comprising the second injection point of the second phase 3, and the feed zone Zₓ comprising the first injection point of the first phase 2, x being greater than or equal to 1, preferably x being greater than 1; and
at least one backwash zone defining the backwash sector 8, i.e. the backwash zone(s) are located between the zone Zₓ₊₁ and the column bottom zone Zₙ comprising the third injection point for the backwash liquid 4, n being greater than x.

According to the invention, each extraction and backwash zone comprises at least two trays, each extraction and backwash zone defining the structural characteristics of the perforated trays Pᵢ present in said extraction and backwash zones. Thus, according to the invention, the perforated trays Pᵢ of the same extraction or backwash zone have substantially the same number of holes 9 per perforated tray Pᵢ.

According to one or more embodiments, with reference to FIG. 3, the at least one backwash zone is a plurality of zones subdivided into a plurality of zones Zⱼ located between the zone Zₓ₊₁ and the column bottom zone Zₙ.

Advantageously, the number of zones Zᵢ and Zⱼ can be defined relative to the flow rate variability and the physicochemical properties of the phase passing through said zones Zᵢ and Zⱼ.

According to one or more embodiments, the total number n of zones is between 2 and 30, preferably between 3 and 30, very preferably between 4 and 24, such as between 4 and 18, in particular between 4 and 8.

In the present description, i, j, x and n are natural integers.

The number of extraction zones Zᵢ can be defined relative to the phase that has the most flow rate variability in the column. According to one or more embodiments, the number of zones Zᵢ (number of zones Z₁ to Zₓ) is between 1 and 10, preferably between 2 and 10, very preferably between 2 and 6, such as between 2 and 4.

The number of backwash zones Zⱼ can be defined relative to the phase that has the most flow rate variability in the column. According to one or more embodiments, the number of backwash zones (number of zones Zₓ₊₁ to Zₙ) is between 1 and 10, preferably between 1 and 6, very preferably between 1 and 4. According to one or more embodiments, the number of backwash zones (number of zones Zₓ₊₁ to Zₙ) is greater than or equal to 2.

According to one or more embodiments, the number of trays per zone Zᵢ and Zⱼ can be determined by the number of actual stages required for the separation divided by the number of zones Zᵢ and Zⱼ.

Control of the flow rate variation of the dispersed phase Advantageously, the liquid-liquid extraction column 1 according to the invention comprises perforated trays Pi comprising a variable number of holes 9 so that the axial velocity (parallel to the central axis Z of the column) of the dispersed phase through the perforations remains substantially constant in the column. Indeed, due to the fluctuation of the flow rate of the dispersed phase and the physicochemical properties of the dispersed phase as it passes through the column, the variation of the number of holes in the perforated trays Pᵢ ensures that a minimum thickness of coalesced layer is maintained and that the hydraulic injection conditions in the column are identical. This solution also reduces the axial mixing of the continuous phase.

Specifically, in order to keep the axial velocity of the dispersed phase through the perforations substantially constant in the column, the liquid-liquid extraction column 1 according to the invention is divided into:
x zones Zᵢ, of which zones Z₁ to Zₓ are located from the second withdrawal point for the raffinate 6 to the first injection point for the first phase 2 (phase to be separated),
n-x zones Zⱼ, of which zones Zₓ₊₁ to Zₙ are located from the point below the first phase 2 (phase to be separated) to the extract 5 withdrawal point at the bottom of the column.

According to the invention, when x is equal to 1, the number of holes in the perforated trays Pᵢ of the at least one backwash zone (e.g. zone Z₂) is greater or less than the number of holes in the perforated trays Pᵢ of zone Z₁. According to one or more embodiments, when x is equal to 1, the ratio of the number of holes in the perforated trays Pᵢ of the at least one backwash zone (e.g. the zone Z₂) to the number of holes in the perforated trays Pᵢ of the zone Z₁ is between 0.40 and 0.95, preferably between 0.60 and 0.95, very preferably between 0.80 and 0.95. According to one or more embodiments, when x is equal to 1, the ratio of the number of holes in the perforated trays Pᵢ of the zone Z₁ to the number of holes in the perforated trays Pᵢ of the at least one backwash zone (e.g. the zone Z₂) is between 0.40 and 0.95, preferably between 0.60 and 0.95, very preferably between 0.80 and 0.95.

According to the invention, when x is greater than 1, in the extraction zones Zᵢ where i ranges from 1 to x (in the extraction sector 7), the number of holes in the perforated trays Pᵢ increases as the value i increases. According to one or more embodiments, in the zones Zᵢ where i ranges from 1 to x, the ratio of the number of holes in the perforated trays Pᵢ of a zone Zᵢ to the number of holes in the perforated trays Pᵢ of a zone Zᵢ₊₁ is between 0.40 and 0.95, preferably between 0.60 and 0.95, very preferably between 0.80 and 0.95.

According to one or more embodiments, in the zones Zⱼ where j ranges from x+1 to n (in the backwash sector 8), the number of holes 9 in the perforated trays Pᵢ is substantially constant.

According to one or more embodiments, in the zones Zⱼ where j ranges from x+1 to n, the number of holes 9 in the perforated trays Pᵢ increases as the value i increases. According to one or more embodiments, in the zones Zⱼ where j ranges from x+1 to n, the ratio of the number of holes 9 in the perforated trays Pᵢ of a zone Zⱼ to the number of holes 9 in the perforated trays Pᵢ of a zone Zⱼ₊₁ is between 0.70 and 0.95, preferably between 0.70 and 0.90, very preferably between 0.80 and 0.90.

According to one or more embodiments, the number of holes 9 in the perforated trays Pᵢ of the backwash zone Zₓ₊₁ is less than, equal to or greater than the number of holes 9 in the perforated trays Pᵢ of the extraction zone Zₓ. According to one or more embodiments, the ratio of the number of holes in the perforated trays Pᵢ of the backwash zone Zₓ₊₁ to the number of holes in the perforated trays Pᵢ of the extraction zone Zₓ is between 0.40 and 0.95, preferably between 0.60 and 0.95, very preferably between 0.80 and 0.95. According to one or more embodiments, the ratio of the number of holes in the perforated trays Pᵢ of the extraction zone Zₓ to the number of holes in the perforated trays Pᵢ of the backwash zone Zₓ₊₁ is between 0.40 and 0.95, preferably between 0.60 and 0.95, very preferably between 0.80 and 0.95.

According to one or more embodiments, each perforated tray Pᵢ has a number of holes of between 3000 and 20 000. According to one or more embodiments, for each tray Pᵢ, the ratio of the hole area to the total tray area is less than 0.5. According to one or more embodiments, the ratio of the hole area to the total tray area is between 0.005 and 0.2, such as between 0.01 and 0.1. According to one or more embodiments, the hole size of all the trays in the column is substantially constant. According to one or more embodiments, the diameter of the holes 9 in the trays Pᵢ is between 2 mm and 20 mm, preferably between 4 mm and 15 mm, very preferably between 5 mm and 10 mm.

### EXAMPLES

### Example 1: Liquid-Liquid Extraction Column with a Variable Number of Holes

This example is directed towards describing the effect of adjusting the number of holes on the homogeneity of the axial velocities of the dispersed phase and the height of the coalesced layer.

The column has a diameter of 2.9 m and comprises a succession of 108 perforated trays. The feedstock is injected at intermediate tray No. 47. The heavy solvent is injected at the top of the column at tray 1. The counter solvent is injected at the bottom of the column at tray 108.

Three zones are defined to adjust the number of holes to the variations of flow rate of the dispersed phase along the column:
the first zone, Z1, is between trays 1 and 27: the number of holes is 3300, the rest of the geometry being unchanged;
the second zone, Z2, is between trays 28 and 47: the number of holes is increased to 4000, in view of the increase in the flow rate of the dispersed phase, zones Z1 and Z2 correspond to the extraction sector 7; and
the third zone, Z3, is between trays 48 and 108: this zone corresponds to the backwash sector 8; the number of holes is 5012.

In the extraction sector 7 between the head tray X=1 and the feed tray X=47, the number of holes in zone Z1 is less than the number of holes in zone Z2: the ratio of the number of holes in zone Z1 to the number of holes in zone Z₂ is 0.83.

In the backwash sector 8 between the tray x=48 and the bottom tray x=108, the number of holes in zone Z2 is less than the number of holes in zone Z3: the ratio of the number of holes in zone Z2 to the number of holes in zone Z3 is 0.80.

FIG. 4 illustrates the technical effect of this adjustment: it ensures homogeneity of hydraulic functioning along the column. Firstly, this adjustment makes it possible to obtain a coalesced layer thickness above the tray which is always within an optimal range so as to prevent the continuous phase from passing through the tray. Secondly, this adjustment keeps the axial velocity of the dispersed phase through the tray perforations substantially constant throughout the column: thus, in this example, the velocity distribution is centred around a reference velocity with a standard deviation of 0.02.

The adjustment of the number of perforations thus ensures constant performance regardless of variations in the flow rate of the dispersed phase along the column.

### Counter-Example 2: Liquid-Liquid Extraction Column with a Constant Number of Holes

The column has a diameter of 2.9 m, a height of 42 m and is composed of a succession of 108 perforated trays. The feedstock is injected at intermediate tray No. 47. The heavy solvent is injected at the top of the column at tray 1. The counter solvent is injected at the bottom of the column at tray 108.

No adjustment is made: the number of holes is constant (5012 holes) and the characteristics of the trays are identical in all points.

FIG. 5 illustrates that, without adjustment of the number of holes, the thickness of the coalesced layer is too low for trays No. 1 to 40, i.e. more than 35% of the trays, which can lead to hydraulic malfunction and thus degrade the efficiency of the extraction sector.

Moreover, the non-adjustment of the number of holes leads to velocity heterogeneities through the perforations of the trays: the velocity distribution along the column can vary between 60% and 115% of the reference velocity (standard deviation=0.15). Such functioning leads to a decrease in the interfacial area of more than 50% in the low velocity zones, and thus to degradation of the column efficiency.

1. Liquid-liquid extraction column (1) comprising the following elements:
a first injection point for a first phase (2) located at an intermediate position between the top and the bottom of the column (1);
a second injection point for a second phase (3) and a third injection point for a backwash liquid (4), one being located at the top of the column (1) and the other being located at the bottom of the column (1);
a first withdrawal point for an extract (5) and a second withdrawal point for a raffinate (6), one being located at the bottom of the column (1) and the other being located at the top of the column (1);
a plurality of trays (Pᵢ) located from the top of the column (1) to the bottom of the column (1) and defining n zones, each zone comprising at least two trays (Pi), n being between 2 and 30;
in which the n zones comprise:
at least one extraction zone Zᵢ located between a zone Zᵢ comprising the second injection point for the second phase (3), and a feed zone Zₓ comprising the first injection point for the first phase (2), x being greater than or equal to 1; and
at least one backwash zone located between a zone Zₓ₊₁ and a zone Zₙ comprising the third injection point for the backwash liquid (4), n being greater than x;
in which the trays (Pi) of the same zone have the same number of holes (9); and
in which:
when x is greater than 1, the number of holes (9) per perforated tray (Pᵢ) of the zones Zᵢ increases as the value i increases; and
when x is equal to 1, the number of holes (9) per perforated tray (Pᵢ) of the at least one backwash zone is less than or greater than than the number of holes (9) per perforated tray (Pᵢ) of the zone Zᵢ.

2. Liquid-liquid extraction column (1) according to claim 1, in which, when x is 1, the ratio of the number of holes per perforated tray of the at least one backwash zone to the number of holes per perforated tray of the zone Z₁ is between 0.40 and 0.95, or the ratio of the number of holes per perforated tray of the zone Z₁ to the number of holes per perforated tray of the at least one backwash zone is between 0.40 and 0.95.

3. Liquid-liquid extraction column (1) according to claim 1, in which n is between 3 and 30, et x is greater than 1.

4. Liquid-liquid extraction column (1) according to claim 3, in which, in the extraction zones Zᵢ where i ranges from 1 to x, the ratio of the number of holes (9) per perforated tray (Pᵢ) of a zone Zᵢ to the number of holes (9) per perforated tray (Pᵢ) of a zone Zᵢ₊₁ is between 0.40 and 0.95.

5. Liquid-liquid extraction column (1) according to claim 3, in which, in the extraction zones Zᵢ where i ranges from 1 to x, the ratio of the number of holes (9) per perforated tray (Pᵢ) of a zone Zᵢ to the number of holes (9) per perforated tray (Pᵢ) of a zone Zᵢ₊₁ is between 0.80 and 0.95.

6. Liquid-liquid extraction column (1) according to claim 1, in which the at least one backwash zone is a plurality of zones, from a zone Zₓ₊₁ to zone Zₙ, and in which the number of holes (9) per perforated tray (Pᵢ) is constant from zone Zₓ₊₁ to zone Zₙ.

7. Liquid-liquid extraction column (1) according to claim 1, in which the at least one backwash zone is a plurality of zones, from a zone Zₓ₊₁ to zone Zₙ, and in which the number of holes (9) per perforated tray (Pᵢ) increases from zone Zₓ₊₁ to zone Zₙ.

8. Liquid-liquid extraction column (1) according to claim 1, in which:
the at least one backwash zone is a plurality of zones Zⱼ between zone Zₓ₊₁ and zone Zₙ, and
in the zones Zⱼ where j ranges from x+1 to n, the ratio of the number of holes (9) per perforated tray (Pᵢ) of a zone Zⱼ to the number of holes (9) per perforated tray (Pᵢ) of a zone Zⱼ₊₁ is between 0.70 and 0.95.

9. Liquid-liquid extraction column (1) according to claim 8, in which, in the zones Zⱼ where j ranges from x+1 to n, the ratio of the number of holes (9) per perforated tray (Pᵢ) of a zone Zⱼ to the number of holes (9) per perforated tray (Pᵢ) of a zone Zⱼ+1 is between 0.70 and 0.90.

10. Liquid-liquid extraction column (1) according to claim 8, in which, in the zones Zⱼ where j ranges from x+1 to n, the ratio of the number of holes (9) per perforated tray (Pᵢ) of a zone Zⱼ to the number of holes (9) per perforated tray (Pᵢ) of a zone Zⱼ+1 is between 0.80 and 0.90.

11. Liquid-liquid extraction column (1) according to claim 3, in which the number of zones Zᵢ is between 2 and 10 and/or the number of backwash zones is between 1 and 10.

12. Liquid-liquid extraction column (1) according to claim 1, in which the number of holes (9) in the perforated trays (Pᵢ) of the backwash zone Zₓ₊₁ is less than, equal to or greater than the number of holes (9) in the perforated trays (Pᵢ) of the extraction zone Zₓ.

13. Liquid-liquid extraction column (1) according to claim 1, in which each perforated tray (Pᵢ) has a number of holes (9) of between 3000 and 20000.

14. Liquid-liquid extraction column (1) according to claim 1, in which the ratio of the area of the holes (9) of each tray (Pi) to the total area of each tray (Pi) is less than 0.5.

15. Liquid-liquid extraction column (1) according to claim 1, in which the diameter of the holes (9) of the trays (Pi) is between 2 mm and 20 mm.
